(19) United States
(12) Patent Application Publication
(10) Pub. No.: US 2024/0354890 A1
(43) Pub. Date: Oct. 24, 2024

(54) EFFICIENT ANALYSIS OF IMAGE DATA USING UNCERTAINTY MAPS

(71) Applicant: International Business Machines Corporation, Armonk, NY (US)

(72) Inventors: Thomas Brunschwiler, Thalwil (CH); Jonas Weiss, Oberrieden (CH); Paolo Fraccaro, Warrington (GB); Maciel Zortea, Rio de Janeiro (BR); Michal Muszynski, Adliswil (CH); Tobia Claglüna, Zürich (CH); Tobias Hölzer, Berlin (DE)

(21) Appl. No.: 18/136,838

(22) Filed: Apr. 19, 2023

(51) Int. Cl. G06T 3/40; G06T 5/50; G06T 7/11; G06V 10/25; G06V 10/764

(52) U.S. Cl. CPC G06T 3/40; G06T 5/50; G06T 7/11; G06V 10/25; G06V 10/764; G06T 2207/20016; G06T 2207/20221

(57) ABSTRACT

A computer-implemented method, system, and computer program product for efficient analysis of image data. An image with the lowest resolution is retrieved. A machine learning model is then used to perform image analysis on the image to generate a pixel-wise classification and an uncertainty map. A segment of the image with an area of uncertainty that is beyond an uncertainty threshold as indicated in the uncertainty map is then retrieved at a higher resolution to be analyzed using the model as discussed above. The process of retrieving further segments of the image at a higher resolution to be analyzed using the model continues until there are no more areas of uncertain classification within the uncertainty map that are beyond the uncertainty threshold. The image analysis result segments of the image at a higher resolution are merged to replace those image analysis result segments at a lower resolution.

### TECHNICAL FIELD

The present disclosure relates generally to image analysis, and more particularly to efficiently analyzing image data, such as multi-modal satellite images, using uncertainty maps.

### BACKGROUND

Image analysis or imagery analysis is the extraction of meaningful information from images, such as from digital images by means of digital image processing techniques. Image analysis tasks can be as simple as reading bar coded tags or as sophisticated as identifying a person from their face.

### SUMMARY

In one embodiment of the present disclosure, a computer-implemented method for efficient analysis of image data comprises retrieving an image of an area of interest with a first resolution. The method further comprises performing image analysis on the image with the first resolution to generate an image analysis result and an uncertainty map for the image with the first resolution. The method additionally comprises identifying an area in the uncertainty map for the image with the first resolution with an uncertainty beyond a defined uncertainty threshold. Furthermore, the method comprises retrieving a segment of the image with a second resolution corresponding to the area in the uncertainty map for the image with the first resolution with the uncertainty beyond the defined uncertainty threshold. Additionally, the method comprises performing image analysis on the segment of the image with the second resolution to generate an image analysis result and an uncertainty map for the image with the second resolution. In addition, the method comprises merging the image analysis result of the segment of the image with the second resolution with a corresponding image analysis result of the segment of the image with the first resolution.

Other forms of the embodiment of the computer-implemented method described above are in a system and in a computer program product.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components used by the image analytics mechanism to generate multi-modal images for optimally performing multi-modal image analytics in accordance with an embodiment of the present disclosure;

FIG. 3 illustrates performing image analysis on an image of an area of interest in accordance with an embodiment of the present disclosure;

FIG. 4 illustrates merging the classified pixels with different resolutions in accordance with an embodiment of the present disclosure;

FIG. 5 illustrates an embodiment of the present disclosure of the hardware configuration of the image analytics mechanism which is representative of a hardware environment for practicing the present disclosure;

FIG. 6 is a flowchart of a method for building and training a machine learning model for performing image analysis to generate a pixel-wise classification and an uncertainty map highlighting the uncertainties of such pixel classifications in accordance with an embodiment of the present disclosure;

FIG. 7 is a flowchart of a method for image pre-processing in accordance with an embodiment of the present disclosure; and

FIG. 8 is a flowchart of a method for efficiently analyzing image data, such as satellite multi-modal image data, using uncertainty maps in accordance with an embodiment of the present disclosure.

### DETAILED DESCRIPTION

As stated in the Background section, image analysis or imagery analysis is the extraction of meaningful information from images, such as from digital images by means of digital image processing techniques. Image analysis tasks can be as simple as reading bar coded tags or as sophisticated as identifying a person from their face.

Computers are indispensable for the analysis of large amounts of data, for tasks that require complex computation, or for the extraction of quantitative information. For example, multi-modal images, such as satellite images of planet Earth, require multi-modal image analytics performed by computers to analyze such images. Multi-modal images refer to the incorporation of two or more imaging modalities (e.g., red, green and blue (RGB) images and radar images). The analysis of such multi-modal images may involve image segmentation, where images are classified according to their visual content.

Unfortunately, the volume of such multi-modal images to be analyzed, such as multi-modal satellite images of planet Earth, is an extremely large amount of Earth observation data. For example, the number of images (with resolution of 224×224) to classify all of planet Earth/day at the resolution of 10×10 m² is 100 million multi-modal images/day. In another example, the number of images (with resolution of 224×224) to classify all of planet Earth/day at the resolution of 1×1 m² is 100,000 million multi-modal images/day.

Currently, there is not an efficient manner for analyzing (e.g., classifying) such multi-modal images. As a result, due to the complexity in analyzing such multi-modal images, the energy consumed by the network in transferring such images and computers analyzing such images is extensive.

The embodiments of the present disclosure provide a means for efficiently analyzing image data, such as satellite multi-modal image data, using uncertainty maps. By more efficiently analyzing such image data, the energy consumed by the network transferring such images and computers analyzing such images is dramatically reduced. In one embodiment, the images to be analyzed are downsampled using various scaling factors forming images of areas of interest with various resolutions, including lower resolutions than the original resolution of the downsampled images. As a result, in one embodiment, images of the same areas of interest at different resolutions are generated and stored at different resolution levels or hierarchies within a database. “Downsampling,” as used herein, refers to the reduction in spatial resolution while keeping the same two-dimensional geographical dimensions. It is used to reduce the storage and/or transmission requirements of images. The scaling factor, as used herein, refers to the ratio between the scale of the original image and the downsampled image, which is its representation but at a lower resolution. In one embodiment, such a sampling factor is less than 1 (resolution of the image is reduced and the destination pixels are larger than the source pixels). An image analysis is then performed on the downsampled image, such as the downsampled image with the lowest resolution, using a machine learning model forming a pixel-wise classification and an uncertainty map. The uncertainty map highlights areas of the image with uncertain classifications. The segment of the image with such an area of uncertainty that is beyond a defined uncertainty threshold is then retrieved at a higher resolution. The retrieved segment of the image at a higher resolution is then analyzed using a machine learning model forming a pixel-wise classification and an uncertainty map. The analysis of the uncertainty map is again performed as discussed above and a further retrieval of a segment of the image at an even higher resolution may be retrieved if necessary. Once there are no more areas of uncertain classification within the uncertainty map that are beyond the defined uncertainty threshold or the highest resolution was reached, the segments of the results of the image analysis of the segments at a higher resolution are merged to replace those results of the image analysis of the segments of the original image at a lower resolution. Since the image contains segments at the lowest resolution necessary in order to perform image analysis (e.g. multi-modal image analysis), such as in a given location, the complexity of the analysis is reduced resulting in less energy consumed by the computers analyzing such images. These and other features will be discussed in further detail below.

In some embodiments of the present disclosure, the present disclosure comprises a computer-implemented method, system and computer program product for efficient analysis of image data. In one embodiment of the present disclosure, an image of an area of interest (e.g., multi-modal satellite image) with the lowest resolution is retrieved, such as from a database. A machine learning model is then used to perform image analysis on the image to generate a pixel-wise classification of the image and an uncertainty map for the image. A “pixel-wise classification,” as used herein, refers to annotating or classifying pixels as belonging to a class (e.g., land, water) at the pixel level. An “uncertainty map,” as used herein, displays the uncertainty of the machine learning model's decision as to the classification of the pixels. The segment of the image with an area of uncertainty that is beyond a defined uncertainty threshold is then retrieved at a higher resolution. The retrieved segment of the image at a higher resolution is then analyzed using a machine learning model forming a pixel-wise classification and an uncertainty map. In an iterative manner, the analysis of the uncertainty map is again performed as discussed above and a further retrieval of a segment of the image at an even higher resolution may be retrieved if necessary. Once there are no more areas of uncertain classification within the uncertainty map that are beyond the defined uncertainty threshold or if the highest resolution was retrieved, the segments of the results of the image analysis of the segments at a higher resolution are merged to replace those results of the image analysis of the segments of the original image at a lower resolution. In this manner, the complexity of the analysis (e.g. multi-modal image analysis) is reduced resulting in less energy consumed by the computers analyzing such images since such images contain segments at the lowest resolution necessary to perform such an analysis.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted in as much as such details are not necessary to obtain a complete understanding of the present disclosure and are within the skills of persons of ordinary skill the relevant art.

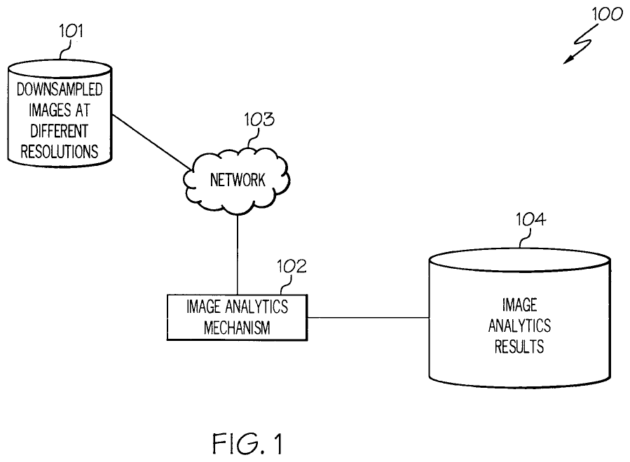

Referring now to the Figures in detail, FIG. 1 illustrates an embodiment of the present disclosure of a communication system 100 for practicing the principles of the present disclosure. Communication system 100 includes a database 101 storing images, such as satellite multi-modal images, with the original resolution. In one embodiment, database 101 is connected to an image analytics mechanism 102 via a network 103.

Network 103 may be, for example, a local area network, a wide area network, a wireless wide area network, a circuit-switched telephone network, a Global System for Mobile communications (GSM) network, a Wireless Application Protocol (WAP) network, a WiFi network, an IEEE 802.11 standards network, various combinations thereof, etc. Other networks, whose descriptions are omitted here for brevity, may also be used in conjunction with system 100 of FIG. 1 without departing from the scope of the present disclosure.

As discussed above, the images stored in database 101 are stored at the original resolution, which may correspond to a high resolution. Images with a higher resolution have more pixels per inches than images with a lower resolution. While there is more pixel information, and hence a higher-quality of an image, the processing or analyzing of such images (e.g., multi-modal image analysis) is a longer and slower process as well as more computationally and energy expensive. As a result, if portions of such images that do not need such high resolutions in order for such analysis (e.g., multi-modal image analysis) to be effectively performed could be replaced with lower resolution segments, then such analysis could be improved in terms of speed and energy. That is, if images at an original resolution could be replaced with corresponding images which contain the maximum amount of lower resolution segments yet still be able to effectively provide the same resulting outcome of the analysis (e.g., multi-modal image analysis) performed on the images at the original resolution, then such an analysis could be improved in terms of speed (since the analysis is less complex) and energy consumption (less complex computations require less energy).

In one embodiment, image analytics mechanism 102 is configured to generate multi-modal images at the lowest resolution for optimally performing multi-modal image analytics. In one embodiment, image analytics mechanism 102 downsamples the images of areas of interest (e.g., satellite images of an area within a state of the United States of America) with an original resolution, such as from database 101, with multiple scaling factors forming images of the areas of interest with multiple resolutions, including lower resolutions than the original resolution. “Downsampling,” as used herein, refers to the reduction in spatial resolution while keeping the same two-dimensional geographical dimensions. It is used to reduce the storage and/or transmission requirements of images through the network. The scaling factor, as used herein, refers to the ratio between the scale of the original image and the downsampled image, which is its representation but at a lower resolution. In one embodiment, such a scaling factor is less than 1 (resolution of the image is reduced and the destination pixels are larger than the source pixels).

In one embodiment, the images of areas of interest are downloaded with various resolutions, such as from database 101, ranging from a lowest resolution to the original resolution, which may correspond to the highest resolution. When images are downsampled at a resolution less than the original resolution, the scaling factor is less than 1.

In one embodiment, the downsampled images are stored at various resolutions in the same database, such as database 101. For example, the downsampled images with different resolutions are stored at different resolution levels or hierarchies within database 101 connected to image analytics mechanism 102. Alternatively, such downsampled images at different resolution levels are stored in multiple databases.

In one embodiment, image analytics mechanism 102 is configured to perform image analysis on the images with the lowest resolution using a machine learning model generating a pixel-wise classification and an uncertainty map. “Pixel-wise classification,” as used herein, refers to annotating or classifying pixels as belonging to a class (e.g., land, water) at the pixel level. An “uncertainty map,” as used herein, displays the uncertainty of the machine learning model's decision as to the classification of the pixels. For example, a pixel of an image of water within a lake would be easily classified as water; whereas, a pixel at the boundary between land and water, such as the shoreline, would have a high degree of uncertainty as to whether the pixel corresponds to land or water. Hence, the uncertainty map highlights areas of the image with uncertain classifications.

In one embodiment, image analytics mechanism 102 is configured to retrieve the segment of the image with an area of uncertainty that is beyond a defined uncertainty threshold, such as from database 101, at a higher resolution. For example, if the area with uncertain classification that is beyond a defined uncertainty threshold pertains to the shoreline of a lake, then the segment of the image pertaining to the shoreline of the lake would be retrieved at a higher resolution. By retrieving such a segment at a higher resolution, there is a better chance that the uncertainty pertaining to pixel classification for such a segment would be satisfactory (i.e., not beyond a defined uncertainty threshold). Upon retrieving such a segment, image analysis is performed on the segment using the machine learning model as discussed above generating a pixel-wise classification and an uncertainty map as discussed above.

If the uncertainty map still indicates an area of uncertainty that is beyond a defined uncertainty threshold, then image analytics mechanism 102 retrieves the segment of the image with an area of uncertainty that is beyond a defined uncertainty threshold, such as from database 101, at a higher resolution and the above-described process continues until the uncertainty map does not indicate any areas with uncertain classifications that exceed the defined uncertainty threshold or after a pre-selected number of iterations.

If, however, the uncertainty map does not indicate any areas with uncertain classifications that exceed the defined uncertainty threshold or the highest resolution was reached, then those classified segments of the image with higher resolutions (i.e., those segments with a higher resolution that were necessarily obtained in order to prevent an uncertain classification that is beyond a defined uncertainty threshold) are merged with the corresponding classified segments of the image with a lower resolution, including the lowest resolution. Such merged classified images are performed on multi-modal images at the lowest resolution for optimally performing multi-modal image analytics, which are stored in database 104 connected to image segmentation mechanism 102, while staying below the requested uncertainty threshold.

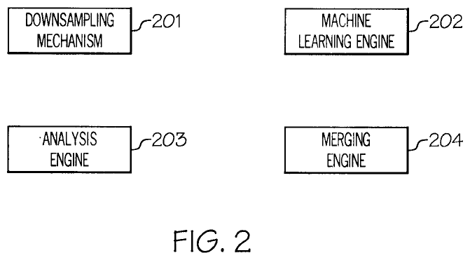

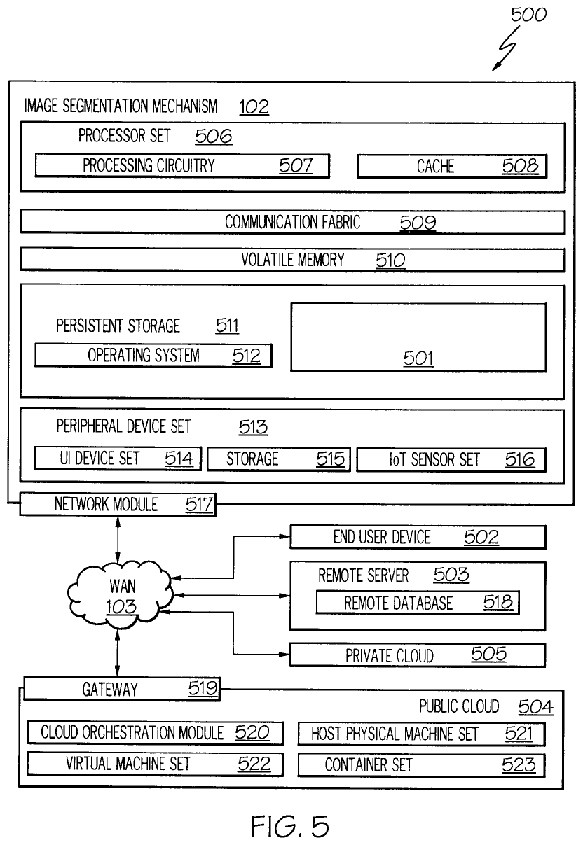

A description of the software components of image analytics mechanism 102 used for generating multi-modal images at the lowest resolution for optimally performing multi-modal image analytics is provided below in connection with FIG. 2. A description of the hardware configuration of image analytics mechanism 102 is provided further below in connection with FIG. 5.

System 100 is not to be limited in scope to any one particular network architecture. System 100 may include any number of databases 101, 104, image analytics mechanisms 102 and networks 103.

A discussion regarding the software components used by image analytics mechanism 102 for generating multi-modal images at the lowest resolution for optimally performing multi-modal image analytics is provided below in connection with FIG. 2.

FIG. 2 is a diagram of the software components used by image analytics mechanism 102 to generate multi-modal images at the lowest resolution for optimally performing multi-modal image analytics in accordance with an embodiment of the present disclosure.

Referring to FIG. 2, in conjunction with FIG. 1, image analytics mechanism 102 includes downsampling mechanism 201 configured to downsample the images of areas of interest (e.g., satellite images of an area within a state of the United States of America) with an original resolution, such as in database 101, with various scaling factors, which may be user-defined, forming images of the areas of interest with multiple resolutions, including lower resolutions than the original resolution of the downsampled image. “Downsampling,” as used herein, refers to the reduction in spatial resolution while keeping the same two-dimensional geographical dimensions. It is used to reduce the storage and/or transmission requirements of images. The scaling factor, as used herein, refers to the ratio between the scale of the original image and the downsampled image, which is its representation but at a lower resolution. In one embodiment, such a scaling factor is less than 1 (resolution of the image is reduced and the destination pixels are larger than the source pixels).

In one embodiment, downsampling mechanism 201 downloads the images of areas of interest with an original resolution, such as from database 101, with various scaling factors thereby forming images of the areas of interest at various resolutions, ranging from the lowest resolution to the original resolution, which may correspond to the highest resolution. When images are downsampled at a resolution less than the original resolution, the scaling factor is less than 1.

In one embodiment, downsampling mechanism 201 implements an image scaling algorithm for performing scaling (including with various scaling factors) of the images stored in database 101 in their original resolution, including, but not limited to, nearest neighbor interpolation, bilinear interpolation, bicubic interpolation, and box sampling.

In one embodiment, downsampling mechanism 201 stores the downsampled images at various resolutions in database 101. In one embodiment, such downsampled images with different resolutions are stored at different resolution levels or hierarchies within database 101 connected to image analytics mechanism 102. Alternatively, such downsampled images at different resolution levels are stored in multiple databases.

Image analytics mechanism 102 further includes a machine learning engine 202 configured to train and build a machine learning model for performing image analysis on the downsampled images stored in database 101. In one embodiment, such an analysis performed by the machine learning model results in generating a pixel-wise classification and an uncertainty map. As discussed above, “pixel-wise classification,” as used herein, refers to annotating or classifying pixels as belonging to a class (e.g., land, water) at the pixel level. An “uncertainty map,” as used herein, displays the uncertainty of the machine learning model's decision as to the classification of the pixels. For example, a pixel of an image of water within a lake would be easily classified as water; whereas, a pixel at the boundary between land and water, such as the shoreline, would have a high degree of uncertainty as to whether the pixel corresponds to land or water. Hence, the uncertainty map highlights areas of the image with uncertain classifications.

In one embodiment, machine learning engine 202 uses a machine learning algorithm (e.g., supervised learning) to build and train a machine learning model for performing image analysis on the downsampled images stored in database 101 in order to generate a pixel-wise classification and an uncertainty map highlighting the uncertainties of such pixel classifications. That is, machine learning engine 202 uses a machine learning algorithm (e.g., supervised learning) to build and train a machine learning model for predicting the class of a pixel of an image and then highlighting the uncertainty in such a pixel classification in an uncertainty map. Such a machine learning model is built using a sample data set containing multi-modal images, such as multi-modal satellite images, as well as corresponding pixel-wise classifications. That is, such a sample data set includes multi-modal images with pixel classifications. For example, the pixels of an image may be classified as land or water.

Such a sample data set is referred to herein as the “training data,” which is used by the machine learning algorithm to make predictions or decisions as to the pixel-wise classification and the uncertainty map that should be generated based on analyzing an image, such as a multi-modal satellite image. The algorithm iteratively makes predictions on the training data as to the pixel-wise classification and the corresponding uncertainty map that should be generated based on analyzing an image until the predictions achieve the desired accuracy as determined by an expert. Examples of such learning algorithms include nearest neighbor, Naïve Bayes, decision trees, linear regression, support vector machines, and neural networks.

In one embodiment, the machine learning model utilized for image classification (classifying pixels of an image) and determining the uncertainty in such pixel classifications is a convolution neural network.

In one embodiment, the machine learning model, such as a Bayesian neural network, computes the probabilities of accurately classifying each pixel. In one embodiment, the machine learning model has a probabilistic layer which outputs an aleatoric uncertainty (data's inherent randomness that cannot be explained away) and an epistemic uncertainty (model uncertainty). In one embodiment, an optimal threshold used to define areas of uncertainty in an uncertainty map may then be learned as a convex combination of both values (aleatoric uncertainty and epistemic uncertainty). In one embodiment, such a threshold corresponds to the defined uncertainty threshold which is used to identify an area of an image that has a degree of uncertainty beyond such a defined uncertainty threshold. A segment of the image corresponding to such an area is then retrieved at a higher resolution as discussed further below.

In one embodiment, an expert defines or specifies such a defined uncertainty threshold. In one embodiment, the defined uncertainty threshold corresponds to an uncertainty value of one pixel or the sum of the nearest neighbor pixels.

In one embodiment, machine learning engine 202 uses probabilistic classification to generate the uncertainty map that displays the uncertainty of the machine learning model's decision as to the classification of the pixel. In probabilistic classification, the method objective is to match the predicted probabilities with pixel classifications, i.e., to maximize the likelihood of observing pixel classifications given the predicted probabilities.

In one embodiment, the probabilistic classification includes utilizing the loglikelihood (logarithm of the likelihood). Since the loglikelihood scales with the number of classifications, an average loglikelihood may be utilized to explain classification variances. In one embodiment, the negative average loglikelihood is minimized to form what is referred to as the “logloss.”

In one embodiment, such a probabilistic classification includes using the Brier Score, which is an evaluation metric for predicted probabilities. The “Brier Score,” as used herein, is a strictly proper score function or a strictly proper scoring rule that measures the accuracy of the probabilistic predictions.

In one embodiment, machine learning engine 202 uses the Monte Carlo dropout technique to generate the uncertainty map. In one embodiment, the Monte Carlo dropout technique generates various predictions (e.g., classify pixel as water, classify pixel as land) and interprets them as classification with a probabilistic distribution. In one embodiment, the uncertainty map is generated based on such an interpretation, such as observing the variance in the Monte Carlo dropout classification during inference.

In another embodiment, machine learning engine 202 generates the uncertainty map based on an ensemble prediction of multiple models. “Ensemble modeling,” as used herein, is a process where multiple diverse models are created to predict an outcome, either by using many different modeling algorithms or using different training data sets. The ensemble model then aggregates the predictions of each base model and results in one final prediction. The variance of the predictions are then used to generate the uncertainty map for the unseen data.

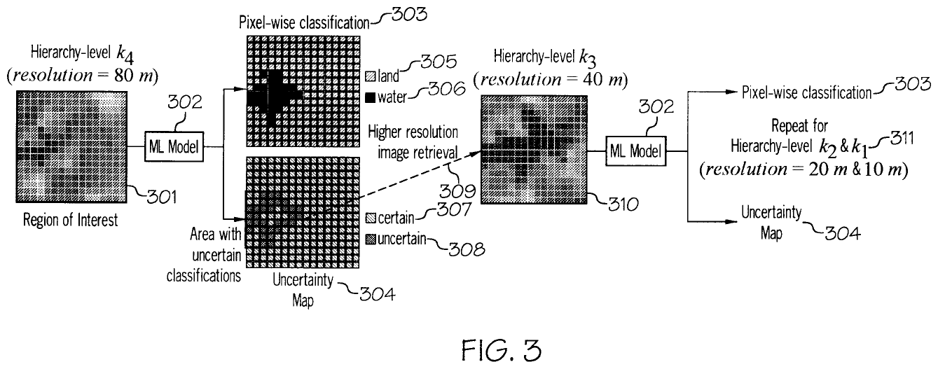

Upon training the machine learning model to generate pixel-wise classifications and an uncertainty map, the machine learning model is utilized to generate a pixel-wise classification and an uncertainty map for images of areas of interest (e.g., multi-modal satellite images) that are retrieved by analysis engine 203 of image analytics mechanism 102. For example, analysis engine 203 retrieves an image of an area of interest (e.g., multi-modal satellite image) with the lowest resolution from database 101. The trained machine learning model then performs image analysis on the retrieved image generating a pixel-wise classification and an uncertainty map as discussed below in connection with FIG. 3.

FIG. 3 illustrates performing image analysis on an image of an area of interest in accordance with an embodiment of the present disclosure.

As shown in FIG. 3, an image 301 of an area of interest with the lowest resolution (e.g., 80 m) was retrieved from database 101 at the lowest resolution level or hierarchy level (e.g., k₄, where k represents the resolution or hierarchy and the subscript represents the level, where the higher the number of the subscript the lower the resolution level or hierarchy level and vice-versa). While the following discusses hierarchy levels k₄-k₁, it is noted that images 301 may be stored in database 101 at any number of resolution levels or hierarchy levels.

Furthermore, as shown in FIG. 3, image analysis is then performed on image 301 by the trained machine learning model (ML-Model) 302, which generates a pixel-wise classification 303 and an uncertainty map 304. As discussed above, “pixel-wise classification 303,” as used herein, refers to annotating or classifying pixels as belonging to a class (e.g., land, water) at the pixel level. An “uncertainty map 304,” as used herein, displays the uncertainty of the machine learning model's decision as to the classification of the pixels.

For example, as shown in FIG. 3, pixel-wise classification 303 involves classifying each pixel as either land 305 or water 306. The uncertainty for such pixel classifications are then displayed in uncertainty map 304, which depicts areas of certain classifications 307 and areas of uncertain classifications 308 based on whether such uncertainties exceed the defined uncertainty threshold. As discussed above, in one embodiment, the defined uncertainty threshold is defined by an expert. Furthermore, as discussed above, in one embodiment, the defined uncertainty threshold corresponds to the optimal threshold which is learned as a convex combination of the aleatoric uncertainty and epistemic uncertainty values.

In one embodiment, analysis engine 203 determines if there are any areas in uncertainty map 304 indicating a level of uncertainty beyond a defined uncertainty threshold. In one embodiment, such areas (see element 308) are indicated in uncertainty map 304.

Based on identifying such areas (see element 308) in uncertainty map 304, analysis engine 203 retrieves (see element 309) a segment of that image (segment corresponding to the area with a level of uncertainty beyond a defined uncertainty threshold) at a higher resolution level or hierarchy (see image 310) from database 101 as shown in FIG. 3.

For example, analysis engine 203 retrieves the segment of that image from database 101 that corresponds to the area with a level of uncertainty beyond a defined uncertainty threshold at the next higher resolution level (e.g., k₃), such as at 40 m, as shown in FIG. 3.

Upon retrieving the segment of the image at a higher resolution level from database 101, such as the next higher resolution level, image analysis is performed on the retrieved segment of the image using the trained machine learning model as discussed above. The above discussed process of performing image analysis and retrieving a segment of the image with a higher resolution is continually repeated for each iteration until there are no more areas of uncertain classification within uncertainty map 304 that are beyond the defined uncertainty threshold or the highest resolution image was retrieved.

For example, further iterations of retrieving segments of the image may involve retrieving segments of the image at the next higher resolution levels (e.g., k₂ followed by k) corresponding to resolutions of 20 m and 10 m, respectively) as illustrated by element number 311 of FIG. 3. In one embodiment, the resolution level of k₁ represents the highest resolution level, such as the original resolution level, and hence no further retrieval of image segments at a higher resolution may occur.

In one embodiment, a machine learning model (a shallow model) with lower accuracy is used to perform the initial pixel-wise classification 303 and uncertainty map 304; however, a more accurate and expensive machine learning model (e.g., deep neural network) is then used for generating pixel-wise classification 303 and uncertainty map 304 for those image segments retrieved due to areas of high uncertainty in uncertainty map 304. For example, the machine learning model utilized in the first iteration (e.g., performing image analysis on images of the lowest resolution) is more shallow than the machine learning model in the second or subsequent iterations (e.g., performing image analysis on image segments at a higher resolution). “Shallow,” as used herein, refers to having fewer hidden layers of nodes.

In one embodiment, the more expensive machine learning model (e.g., deep neural network) is only applied to the complex areas of the image for those image segments with a high uncertainty in uncertainty map 304. In one embodiment, the resolution of the sub-section(s) for which the more expensive machine learning model is applied has the same resolution as other sections of the image. In this manner, only complex areas with be analyzed with an expensive model.

As discussed above, the images downsampled and stored by downsampling mechanism 201 are multi-modal images, such as the incorporation of two or more imaging modalities (e.g., red, green and blue (RGB) images and radar images). In one embodiment, in order to improve efficiency and reduce energy consumption, the most relevant modality may be utilized in the first iteration (e.g., performing image analysis on images with one modality) followed by adding a modality in the second or subsequent iteration (e.g., performing image analysis on image segments at additional modalities).

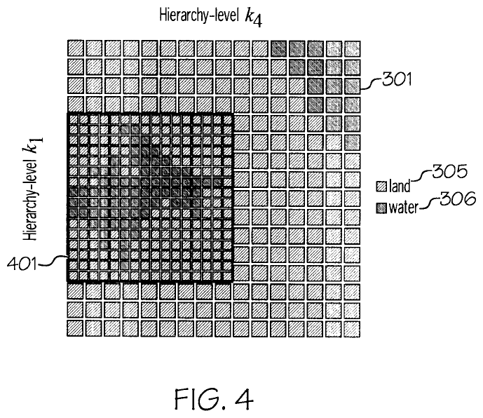

Returning to FIG. 2, image analytics mechanism 102 additionally includes a merging engine 204 configured to merge the analyzed image segments at a higher resolution to replace those analyzed image segments at the lower resolution, iteratively, to form the final analysis as shown in FIG. 4.

Referring to FIG. 4, FIG. 4 illustrates merging the classified pixels with different resolutions in accordance with an embodiment of the present disclosure.

As shown in FIG. 4, the analyzed image segment 401 at a higher resolution, such as at a resolution corresponding to hierarchy level k₁, is merged with the corresponding analyzed image segment in image 301 at a lower resolution, including the lowest resolution, such as corresponding to hierarchy level k₄, to form a new image. In one embodiment, such image analytics results are stored in database 104.

Since these newly formed images contain image segments at the lowest resolution necessary in order to perform multi-modal image analytics, the complexity of the analysis is reduced resulting in faster computations with less energy consumed in analyzing such images. Furthermore, there is a reduction in data transfer.

A further description of these and other features is provided below in connection with the discussion of the method for efficiently analyzing image data, such as multi-modal satellite images, using uncertainty maps.

Prior to the discussion of the method for efficiently analyzing image data, such as multi-modal satellite images, using uncertainty maps, a description of the hardware configuration of image analytics mechanism 102 (FIG. 1) is provided below in connection with FIG. 5.

Referring now to FIG. 5, in conjunction with FIG. 1, FIG. 5 illustrates an embodiment of the present disclosure of the hardware configuration of image analytics mechanism 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 500 contains an example of an environment for the execution of at least some of the computer code (stored in block 501) involved in performing the inventive methods, such as efficiently analyzing image data, such as multi-modal satellite images, using uncertainty maps. In addition to block 501, computing environment 500 includes, for example, image analytics mechanism 102, network 103, such as a wide area network (WAN), end user device (EUD) 502, remote server 503, public cloud 504, and private cloud 505. In this embodiment, image analytics mechanism 102 includes processor set 506 (including processing circuitry 507 and cache 508), communication fabric 509, volatile memory 510, persistent storage 511 (including operating system 512 and block 501, as identified above), peripheral device set 513 (including user interface (UI) device set 514, storage 515, and Internet of Things (IoT) sensor set 516), and network module 517. Remote server 503 includes remote database 518. Public cloud 504 includes gateway 519, cloud orchestration module 520, host physical machine set 521, virtual machine set 522, and container set 523.

Image analytics mechanism 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 518. As is well understood in the art of computer technology, and depending upon the technology, performance of a computer-implemented method may be distributed among multiple computers and/or between multiple locations. On the other hand, in this presentation of computing environment 500, detailed discussion is focused on a single computer, specifically image analytics mechanism 102, to keep the presentation as simple as possible. Image analytics mechanism 102 may be located in a cloud, even though it is not shown in a cloud in FIG. 5. On the other hand, image analytics mechanism 102 is not required to be in a cloud except to any extent as may be affirmatively indicated.

Processor set 506 includes one, or more, computer processors of any type now known or to be developed in the future. Processing circuitry 507 may be distributed over multiple packages, for example, multiple, coordinated integrated circuit chips. Processing circuitry 507 may implement multiple processor threads and/or multiple processor cores. Cache 508 is memory that is located in the processor chip package(s) and is typically used for data or code that should be available for rapid access by the threads or cores running on processor set 506. Cache memories are typically organized into multiple levels depending upon relative proximity to the processing circuitry. Alternatively, some, or all, of the cache for the processor set may be located “off chip.” In some computing environments, processor set 506 may be designed for working with qubits and performing quantum computing.

Computer readable program instructions are typically loaded onto image analytics mechanism 102 to cause a series of operational steps to be performed by processor set 506 of image analytics mechanism 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 508 and the other storage media discussed below. The program instructions, and associated data, are accessed by processor set 506 to control and direct performance of the inventive methods. In computing environment 500, at least some of the instructions for performing the inventive methods may be stored in block 501 in persistent storage 511.

Communication fabric 509 is the signal conduction paths that allow the various components of image analytics mechanism 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 510 is any type of volatile memory now known or to be developed in the future. Examples include dynamic type random access memory (RAM) or static type RAM. Typically, the volatile memory is characterized by random access, but this is not required unless affirmatively indicated. In image analytics mechanism 102, the volatile memory 510 is located in a single package and is internal to image analytics mechanism 102, but, alternatively or additionally, the volatile memory may be distributed over multiple packages and/or located externally with respect to image analytics mechanism 102.

Persistent Storage 511 is any form of non-volatile storage for computers that is now known or to be developed in the future. The non-volatility of this storage means that the stored data is maintained regardless of whether power is being supplied to image analytics mechanism 102 and/or directly to persistent storage 511. Persistent storage 511 may be a read only memory (ROM), but typically at least a portion of the persistent storage allows writing of data, deletion of data and re-writing of data. Some familiar forms of persistent storage include magnetic disks and solid state storage devices. Operating system 512 may take several forms, such as various known proprietary operating systems or open source Portable Operating System Interface type operating systems that employ a kernel. The code included in block 501 typically includes at least some of the computer code involved in performing the inventive methods.

Peripheral device set 513 includes the set of peripheral devices of image analytics mechanism 102. Data communication connections between the peripheral devices and the other components of image analytics mechanism 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 514 may include components such as a display screen, speaker, microphone, wearable devices (such as goggles and smart watches), keyboard, mouse, printer, touchpad, game controllers, and haptic devices. Storage 515 is external storage, such as an external hard drive, or insertable storage, such as an SD card. Storage 515 may be persistent and/or volatile. In some embodiments, storage 515 may take the form of a quantum computing storage device for storing data in the form of qubits. In embodiments where image analytics mechanism 102 is required to have a large amount of storage (for example, where image analytics mechanism 102 locally stores and manages a large database) then this storage may be provided by peripheral storage devices designed for storing very large amounts of data, such as a storage area network (SAN) that is shared by multiple, geographically distributed computers. IoT sensor set 516 is made up of sensors that can be used in Internet of Things applications. For example, one sensor may be a thermometer and another sensor may be a motion detector.

Network module 517 is the collection of computer software, hardware, and firmware that allows image analytics mechanism 102 to communicate with other computers through WAN 103. Network module 517 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 517 are performed on the same physical hardware device. In other embodiments (for example, embodiments that utilize software-defined networking (SDN)), the control functions and the forwarding functions of network module 517 are performed on physically separate devices, such that the control functions manage several different network hardware devices. Computer readable program instructions for performing the inventive methods can typically be downloaded to image analytics mechanism 102 from an external computer or external storage device through a network adapter card or network interface included in network module 517.

WAN 103 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 502 is any computer system that is used and controlled by an end user (for example, a customer of an enterprise that operates image analytics mechanism 102), and may take any of the forms discussed above in connection with image analytics mechanism 102. EUD 502 typically receives helpful and useful data from the operations of image analytics mechanism 102. For example, in a hypothetical case where image analytics mechanism 102 is designed to provide a recommendation to an end user, this recommendation would typically be communicated from network module 517 of image analytics mechanism 102 through WAN 103 to EUD 502. In this way, EUD 502 can display, or otherwise present, the recommendation to an end user. In some embodiments, EUD 502 may be a client device, such as thin client, heavy client, mainframe computer, desktop computer and so on.

Remote server 503 is any computer system that serves at least some data and/or functionality to image analytics mechanism 102. Remote server 503 may be controlled and used by the same entity that operates image analytics mechanism 102. Remote server 503 represents the machine(s) that collect and store helpful and useful data for use by other computers, such as image analytics mechanism 102. For example, in a hypothetical case where image analytics mechanism 102 is designed and programmed to provide a recommendation based on historical data, then this historical data may be provided to image analytics mechanism 102 from remote database 518 of remote server 503.

Public cloud 504 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 504 is performed by the computer hardware and/or software of cloud orchestration module 520. The computing resources provided by public cloud 504 are typically implemented by virtual computing environments that run on various computers making up the computers of host physical machine set 521, which is the universe of physical computers in and/or available to public cloud 504. The virtual computing environments (VCEs) typically take the form of virtual machines from virtual machine set 522 and/or containers from container set 523. It is understood that these VCEs may be stored as images and may be transferred among and between the various physical machine hosts, either as images or after instantiation of the VCE. Cloud orchestration module 520 manages the transfer and storage of images, deploys new instantiations of VCEs and manages active instantiations of VCE deployments. Gateway 519 is the collection of computer software, hardware, and firmware that allows public cloud 504 to communicate through WAN 103.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 505 is similar to public cloud 504, except that the computing resources are only available for use by a single enterprise. While private cloud 505 is depicted as being in communication with WAN 103 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 504 and private cloud 505 are both part of a larger hybrid cloud.

Block 501 further includes the software components discussed above in connection with FIGS. 2-4 to efficiently analyze image data, such as multi-modal satellite images, using uncertainty maps. In one embodiment, such components may be implemented in hardware. The functions discussed above performed by such components are not generic computer functions. As a result, image analytics mechanism 102 is a particular machine that is the result of implementing specific, non-generic computer functions.

In one embodiment, the functionality of such software components of image analytics mechanism 102, including the functionality for efficiently analyzing image data, such as multi-modal satellite images, using uncertainty maps, may be embodied in an application specific integrated circuit.

As stated above, image analysis or imagery analysis is the extraction of meaningful information from images, such as from digital images by means of digital image processing techniques. Image analysis tasks can be as simple as reading bar coded tags or as sophisticated as identifying a person from their face. Computers are indispensable for the analysis of large amounts of data, for tasks that require complex computation, or for the extraction of quantitative information. For example, multi-modal images, such as satellite images of planet Earth, require multi-modal image analytics performed by computers to analyze such images. Multi-modal images refer to the incorporation of two or more imaging modalities (e.g., red, green and blue (RGB) images and radar images). The analysis of such multi-modal images may involve image segmentation, where images are classified according to their visual content. Unfortunately, the volume of such multi-modal images to be analyzed, such as multi-modal satellite images of planet Earth, is an extremely large amount of Earth observation data. For example, the number of images (with resolution of 224×224) to classify all of planet Earth/day at the resolution of 10×10 m² is 100 million multi-modal images/day. In another example, the number of images (with resolution of 224×224) to classify all of planet Earth/day at the resolution of 1×1 m² is 100,000 million multi-modal images/day. Currently, there is not an efficient manner for analyzing (e.g., classifying) such multi-modal images. As a result, due to the complexity in analyzing such multi-modal images, the energy consumed by the network in transferring such images and computers analyzing such images is extensive.

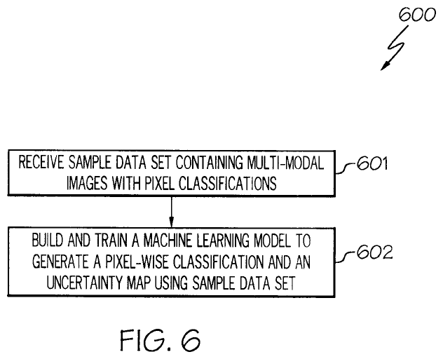

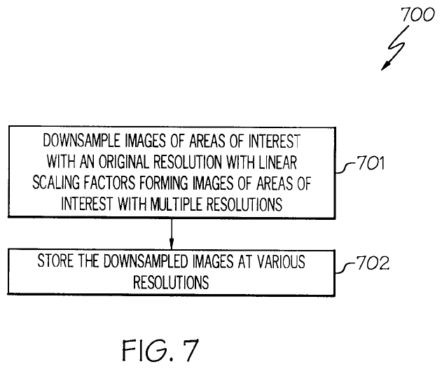

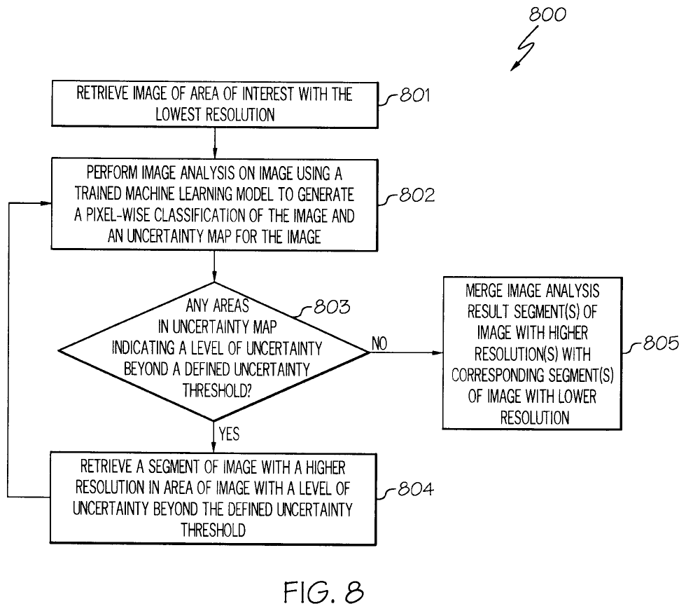

The embodiments of the present disclosure provide a means for efficiently analyzing image data, such as satellite multi-modal image data, using uncertainty maps as discussed below in connection with FIGS. 6-8. By more efficiently analyzing such image data, the energy consumed by computers analyzing such images is dramatically reduced. FIG. 6 is a flowchart of a method for building and training a machine learning model for performing image analysis to generate a pixel-wise classification and an uncertainty map highlighting the uncertainties of such pixel classifications. FIG. 7 is a flowchart of a method for image pre-processing. FIG. 8 is a flowchart of a method for efficiently analyzing image data, such as satellite multi-modal image data, using uncertainty maps.

As stated above, FIG. 6 is a flowchart of a method 600 for building and training a machine learning model for performing image analysis to generate a pixel-wise classification and an uncertainty map highlighting the uncertainties of such pixel classifications in accordance with an embodiment of the present disclosure.

Referring to FIG. 6, in conjunction with FIGS. 1-5, in step 601, machine learning engine 202 of image analytics mechanism 102 receives a sample data set containing multi-modal images with pixel classifications.

In step 602, machine learning engine 202 of image analytics mechanism 102 builds and trains a machine learning model to generate s pixel-wise classification and an uncertainty map using the sample data set.

As discussed above, in one embodiment, machine learning engine 202 trains and builds a machine learning model for performing image analysis on downsampled images stored in database 101. In one embodiment, such an analysis performed by the machine learning model results in generating a pixel-wise classification and an uncertainty map. As discussed above, “pixel-wise classification,” as used herein, refers to annotating or classifying pixels as belonging to a class (e.g., land, water) at the pixel level. An “uncertainty map,” as used herein, displays the uncertainty of the machine learning model's decision as to the classification of the pixels. For example, a pixel of an image of water within a lake would be easily classified as water; whereas, a pixel at the boundary between land and water, such as the shoreline, would have a high degree of uncertainty as to whether the pixel corresponds to land or water. Hence, the uncertainty map highlights areas of the image with uncertain classifications.

In one embodiment, machine learning engine 202 uses a machine learning algorithm (e.g., supervised learning) to build and train a machine learning model for performing image analysis on the downsampled images stored in database 101 in order to generate a pixel-wise classification and an uncertainty map highlighting the uncertainties of such pixel classifications. That is, machine learning engine 202 uses a machine learning algorithm (e.g., supervised learning) to build and train a machine learning model for predicting the class of a pixel of an image and then highlighting the uncertainty in such a pixel classification in an uncertainty map. Such a machine learning model is built using a sample data set containing multi-modal images, such as multi-modal satellite images, as well as corresponding pixel-wise classifications. That is, such a sample data set includes multi-modal images with pixel classifications. For example, the pixels of an image may be classified as land or water.

Such a sample data set is referred to herein as the “training data,” which is used by the machine learning algorithm to make predictions or decisions as to the pixel-wise classification and the uncertainty map that should be generated based on analyzing an image, such as a multi-modal satellite image. The algorithm iteratively makes predictions on the training data as to the pixel-wise classification and the corresponding uncertainty map that should be generated based on analyzing an image until the predictions achieve the desired accuracy as determined by an expert. Examples of such learning algorithms include nearest neighbor, Naïve Bayes, decision trees, linear regression, support vector machines, and neural networks.

In one embodiment, the machine learning model utilized for image classification (classifying pixels of an image) and determining the uncertainty in such pixel classifications is a convolution neural network.

In one embodiment, the machine learning model, such as a Bayesian neural network, computes the probabilities of accurately classifying each pixel. In one embodiment, the machine learning model has a probabilistic layer which outputs an aleatoric uncertainty (data's inherent randomness that cannot be explained away) and an epistemic uncertainty (model uncertainty). In one embodiment, an optimal threshold used to define areas of uncertainty in an uncertainty map may then be learned as a convex combination of both values (aleatoric uncertainty and epistemic uncertainty). In one embodiment, such a threshold corresponds to the defined uncertainty threshold which is used to identify an area of an image that has a degree of uncertainty beyond such a defined uncertainty threshold. A segment of the image corresponding to such an area is then retrieved at a higher resolution as discussed further below.

In one embodiment, an expert defines or specifies such a defined uncertainty threshold. In one embodiment, the defined uncertainty threshold corresponds to an uncertainty value of one pixel or the sum of the nearest neighbor pixels.

In one embodiment, machine learning engine 202 uses probabilistic classification to generate the uncertainty map that displays the uncertainty of the machine learning model's decision as to the classification of the pixel. In probabilistic classification, the method objective is to match the predicted probabilities with pixel classifications, i.e., to maximize the likelihood of observing pixel classifications given the predicted probabilities.

In one embodiment, the probabilistic classification includes utilizing the loglikelihood (logarithm of the likelihood). Since the loglikelihood scales with the number of classifications, an average loglikelihood may be utilized to explain classification variances. In one embodiment, the negative average loglikelihood is minimized to form what is referred to as the “logloss.”

In one embodiment, such a probabilistic classification includes using the Brier Score, which is an evaluation metric for predicted probabilities. The “Brier Score,” as used herein, is a strictly proper score function or a strictly proper scoring rule that measures the accuracy of the probabilistic predictions.

In one embodiment, machine learning engine 202 uses the Monte Carlo dropout technique to generate the uncertainty map. In one embodiment, the Monte Carlo dropout technique generates various predictions (e.g., classify pixel as water, classify pixel as land) and interprets them as classification with a probabilistic distribution. In one embodiment, the uncertainty map is generated based on such an interpretation, such as observing the variance in the Monte Carlo dropout classification during inference.

In another embodiment, machine learning engine 202 generates the uncertainty map based on an ensemble prediction of multiple models. “Ensemble modeling,” as used herein, is a process where multiple diverse models are created to predict an outcome, either by using many different modeling algorithms or using different training data sets. The ensemble model then aggregates the predictions of each base model and results in one final prediction. The variance of the predictions are then used to generate the uncertainty map for the unseen data.

Upon training the machine learning model to generate pixel-wise classifications and an uncertainty map, the trained machine learning model is utilized to generate a pixel-wise classification and an uncertainty map for images of areas of interest (e.g., multi-modal satellite images) as discussed below in connection with FIGS. 7-8.

FIG. 7 is a flowchart of a method 700 for image pre-processing in accordance with an embodiment of the present disclosure.

Referring to FIG. 7, in conjunction with FIGS. 1-6, in step 701, downsampling mechanism 201 of image analytics mechanism 102 downsamples the images of areas of interest (e.g., satellite images of an area within a state of the United States of America) with an original resolution, such as from database 101, with user-defined scaling factors forming images of the areas of interest with multiple resolutions.

As discussed above, in one embodiment, the images stored in database 101 are stored at the original resolution, which may correspond to a high resolution. Images with a higher resolution have more pixels per inches than images with a lower resolution. While there is more pixel information, and hence a higher-quality of an image, the processing or analyzing of such images (e.g., multi-modal image analysis) is a longer and slower process as well as more computationally and energy expensive. As a result, if portions of such images that do not need such high resolutions in order for such analysis (e.g., multi-modal image analysis) to be effectively performed could be replaced with lower resolution segments, then such analysis could be improved in terms of speed and energy. That is, if images at an original resolution could be replaced with corresponding images which contain the maximum amount of lower resolution segments yet still be able to effectively provide the same resulting outcome of the analysis (e.g., multi-modal image analysis) performed on the images at the original resolution, then such an analysis could be improved in terms of speed (since the analysis is less complex) and energy consumption (less complex computations require less energy).

Furthermore, as stated above, downsampling mechanism 201 downsamples the images of areas of interest (e.g., satellite images of an area within a state of the United States of America) with an original resolution, such as from database 101, with multiple scaling factors forming images of the areas of interest with multiple resolutions, including lower resolutions than the original resolution.

As discussed above, “downsampling,” as used herein, refers to the reduction in spatial resolution while keeping the same two-dimensional graphical dimensions. It is used to reduce the storage and/or transmission requirements of images. The scaling factor, as used herein, refers to the ratio between the scale of the original image and the downsampled image, which is its representation but at a lower resolution. In one embodiment, such a scaling factor is less than 1 (resolution of the image is reduced and the destination pixels are larger than the source pixels).

In one embodiment, downsampling mechanism 201 downloads the images of areas of interest with an original resolution, such as from database 101, with various scaling factors thereby forming images of the areas of interest at various resolutions, ranging from the lowest resolution to the original resolution, which may correspond to a high resolution. When images are downsampled at a resolution less than the original resolution, the scaling factor is less than 1.

In one embodiment, downsampling mechanism 201 implements an image scaling algorithm for performing scaling (including with various scaling factors) of the images stored in database 101 in their original resolution, including, but not limited to, nearest neighbor interpolation, bilinear interpolation, bicubic interpolation, and box sampling.

In one embodiment, downsampling mechanism 201 utilizes various software tools for performing image scaling using various scaling factors on the downloaded images (images of areas of interest with an original resolution from database 101), such as, but not limited to, CorelDraw®, GIMP, Adobe® Creative Cloud Express®, etc.

In step 702, downsampling mechanism 201 of image analytics mechanism 102 stores the downsampled images at various resolutions in database 101. In one embodiment, such downsampled images with different resolutions are stored at different resolution levels or hierarchies within database 101. Alternatively, such downsampled images at different resolution levels are stored in multiple databases.

Such downsampled images at the lowest resolution may then be analyzed using the trained machine learning model as discussed below in connection with FIG. 8.

FIG. 8 is a flowchart of a method 800 for efficiently analyzing image data, such as satellite multi-modal image data, using uncertainty maps in accordance with an embodiment of the present disclosure.

Referring to FIG. 8, in conjunction with FIGS. 1-7, in step 801, analysis engine 203 of image analytics mechanism 102 retrieves an image of an area of interest (e.g., multi-modal satellite image) with the lowest resolution from database 101.

In step 802, analysis engine 203 of image analytics mechanism 102 uses the trained machine learning model to perform image analysis on the image to generate pixel-wise classification 303 of the image and uncertainty map 304 for the image.

As discussed above, the trained machine learning model performs image analysis on the retrieved image generating a pixel-wise classification and an uncertainty map as discussed below in connection with FIG. 3.

As shown in FIG. 3, an image 301 of an area of interest with the lowest resolution (e.g., 80 m) was retrieved from database 101 at the lowest resolution level or hierarchy level (e.g., k₄, where k represents the resolution or hierarchy and the subscript represents the level, where the higher the number of the subscript the lower the resolution level or hierarchy level and vice-versa). While the following discusses hierarchy levels k₄-k₁, it is noted that images 301 may be stored in database 101 at any number of resolution levels or hierarchy levels.

Furthermore, as shown in FIG. 3, image analysis is then performed on image 301 by the trained machine learning model (ML-Model) 302, which generates a pixel-wise classification 303 and an uncertainty map 304. As discussed above, “pixel-wise classification 303,” as used herein, refers to annotating or classifying pixels as belonging to a class (e.g., land, water) at the pixel level. An “uncertainty map 304,” as used herein, displays the uncertainty of the machine learning model's decision as to the classification of the pixels.

For example, as shown in FIG. 3, pixel-wise classification 303 involves classifying each pixel as either land 305 or water 306. The uncertainty for such pixel classifications are then displayed in uncertainty map 304, which depicts areas of certain classifications 307 and areas of uncertain classifications 308 based on whether such uncertainties exceed the defined uncertainty threshold. As discussed above, in one embodiment, the defined uncertainty threshold is defined by an expert. Furthermore, as discussed above, in one embodiment, the defined uncertainty threshold corresponds to the optimal threshold which is learned as a convex combination of the aleatoric uncertainty and epistemic uncertainty values.

For example, as shown in FIG. 3, pixel-wise classification 303 involves classifying each pixel as either land 305 or water 306. The uncertainty for such pixel classifications are then displayed in uncertainty map 304, which depicts areas of certain classifications 307 and areas of uncertain classifications 308 based on whether such uncertainties exceed the defined uncertainty threshold. As discussed above, in one embodiment, the defined uncertainty threshold is defined by an expert. Furthermore, as discussed above, in one embodiment, the defined uncertainty threshold corresponds to the optimal threshold which is learned as a convex combination of the aleatoric uncertainty and epistemic uncertainty values.

Returning to FIG. 8, in conjunction with FIGS. 1-7, in step 803, analysis engine 203 of image analytics mechanism 102 determines if there are any areas in uncertainty map 304 indicating a level of uncertainty beyond a defined uncertainty threshold.

As discussed above, in one embodiment, such areas (see element 308) are indicated in uncertainty map 304.

Based on identifying such areas (see element 308) in uncertainty map 304, in step 804, analysis engine 203 of image analytics mechanism 102 retrieves (see element 309) a segment of that image (segment corresponding to the area with a level of uncertainty beyond a defined uncertainty threshold) at a higher resolution level or hierarchy (see image 310) from database 101 as shown in FIG. 3.

For example, analysis engine 203 retrieves the segment of that image from database 101 that corresponds to the area with a level of uncertainty beyond a defined uncertainty threshold at the next higher resolution level (e.g., k₃), such as at 40 m, as shown in FIG. 3.

Upon retrieving the segment of the image at a higher resolution level from database 101, such as the next higher resolution level, analysis engine 203 of image analytics mechanism 102 performs image analysis on the retrieved segment of the image using the trained machine learning model as discussed above in connection with step 802. The above discussed process of performing image analysis and retrieving a segment of the image with a higher resolution is continually repeated until there are no more areas of uncertain classification within uncertainty map 304 that are beyond the defined uncertainty threshold.

For example, further iterations of retrieving segments of the image may involve retrieving segments of the image at the next higher resolution levels (e.g., k₂ followed by k) corresponding to resolutions of 20 m and 10 m, respectively) as illustrated by element number 311 of FIG. 3. In one embodiment, the resolution level of k₁ represents the highest resolution level, such as the original resolution level, and hence no further retrieval of image segments at a higher resolution may occur.

In one embodiment, a machine learning model (a shallow model) with lower accuracy is used to perform the initial image analysis; however, a more accurate and expensive machine learning model (e.g., deep neural network) is then used for generating pixel-wise classification 303 and uncertainty map 304 for those image segments retrieved due to areas of high uncertainty in uncertainty map 304. For example, the machine learning model utilized in the first iteration (e.g., performing image analysis on images of the lowest resolution) is more shallow than the machine learning model in the second or subsequent iterations (e.g., performing image analysis on image segments at a higher resolution). “Shallow,” as used herein, refers to having fewer hidden layers of nodes.

In one embodiment, the more expensive machine learning model (e.g., deep neural network) is only applied to the complex areas of the image for those image segments with a high uncertainty in uncertainty map 304. In one embodiment, the resolution of the sub-section(s) for which the more expensive machine learning model is applied has the same resolution as other sections of the image. In this manner, only complex areas with be analyzed with an expensive model.

As discussed above, the images downsampled and stored by downsampling mechanism 201 are multi-modal images, such as the incorporation of two or more imaging modalities (e.g., red, green and blue (RGB) images and radar images). In one embodiment, in order to improve efficiency and reduce energy consumption, the most relevant modality may be utilized in the first iteration (e.g., performing image analysis on images with one modality) followed by adding a modality in the second or subsequent iteration (e.g., performing image analysis on image segments at additional modalities).

Returning to step 803 of FIG. 8, if, however, there are no areas in uncertainty map 304 indicating a level of uncertainty beyond a defined uncertainty threshold, then, in step 805, merging engine 204 of image analytics mechanism 102 merges the image segments at a higher resolution with corresponding segments at the lower resolution to form a new image as shown in FIG. 4.

As shown in FIG. 4, the analyzed image segment 401 at a higher resolution, such as at a resolution corresponding to hierarchy level k₁, is merged with the corresponding analyzed image segment in image 301 at a lower resolution, including the lowest resolution, such as corresponding to hierarchy level k₄, to form a new image. In one embodiment, such image analytics results are stored in database 104.

In one embodiment, merging engine 204 utilizes various software tools for performing such merging, including, but not limited to, Picosmos, ImFusion, TESCAN 3DIM, etc.

Since these newly formed images contain image segments at the lowest resolution necessary in order to perform multi-modal image analytics, the complexity of the analysis is reduced resulting in faster computations with less energy consumed in analyzing such images. Furthermore, there is a reduction in data transfer.

In this manner, the principles of the present disclosure improve the efficiency in analyzing images, such as multi-modal satellite images, by forming images that contain image segments at the lowest resolution necessary in order to perform multi-modal image analytics. Such images are formed based on utilizing a machine learning model that generates a pixel-wise classification of an image at the lowest resolution and an uncertainty map that highlights areas of the image with uncertain classifications. Using the uncertainty map, segments of the image are retrieved at a higher resolution for only those areas of the image with an uncertainty that is beyond a defined uncertainty threshold as indicated in the uncertainty map. Those segments at a higher resolution then replace those segments in the original image at the lowest resolution to form new images. By forming such new images that contain image segments at the lowest resolution necessary in order to perform multi-modal image analytics, the complexity of the analysis is reduced thereby resulting in faster computations with less energy consumed in analyzing such images.

Furthermore, the principles of the present disclosure improve the technology or technical field involving image analysis. As discussed above, image analysis or imagery analysis is the extraction of meaningful information from images, such as from digital images by means of digital image processing techniques. Image analysis tasks can be as simple as reading bar coded tags or as sophisticated as identifying a person from their face. Computers are indispensable for the analysis of large amounts of data, for tasks that require complex computation, or for the extraction of quantitative information. For example, multi-modal images, such as satellite images of planet Earth, require multi-modal image analytics performed by computers to analyze such images. Multi-modal images refer to the incorporation of two or more imaging modalities (e.g., red, green and blue (RGB) images and radar images). The analysis of such multi-modal images may involve image segmentation, where images are classified according to their visual content. Unfortunately, the volume of such multi-modal images to be analyzed, such as multi-modal satellite images of planet Earth, is an extremely large amount of Earth observation data. For example, the number of images (with resolution of 224×224) to classify all of planet Earth/day at the resolution of 10×10 m² is 100 million multi-modal images/day. In another example, the number of images (with resolution of 224×224) to classify all of planet Earth/day at the resolution of 1×1 m² is 100,000 million multi-modal images/day. Currently, there is not an efficient manner for analyzing (e.g., classifying) such multi-modal images. As a result, due to the complexity in analyzing such multi-modal images, the energy consumed by the network in transferring such images and computers analyzing such images is extensive.

Embodiments of the present disclosure improve such technology by retrieving an image of an area of interest (e.g., multi-modal satellite image) with the lowest resolution, such as from a database. A machine learning model is then used to perform image analysis on the image to generate a pixel-wise classification of the image and an uncertainty map for the image. A “pixel-wise classification,” as used herein, refers to annotating or classifying pixels as belonging to a class (e.g., land, water) at the pixel level. An “uncertainty map,” as used herein, displays the uncertainty of the machine learning model's decision as to the classification of the pixels. The segment of the image with an area of uncertainty that is beyond a defined uncertainty threshold is then retrieved at a higher resolution. The retrieved segment of the image at a higher resolution is then analyzed using a machine learning model forming a pixel-wise classification and an uncertainty map. In an iterative manner, the analysis of the uncertainty map is again performed as discussed above and a further retrieval of a segment of the image at an even higher resolution may be retrieved if necessary. Once there are no more areas of uncertain classification within the uncertainty map that are beyond the defined uncertainty threshold or if the highest resolution was retrieved, the segments of the results of the image analysis of the segments at a higher resolution are merged to replace those results of the image analysis of the segments of the original image at a lower resolution. In this manner, the complexity of the analysis (e.g. multi-modal image analysis) is reduced resulting in less energy consumed by the computers analyzing such images since such images contain segments at the lowest resolution necessary to perform such an analysis. Furthermore, in this manner, there is an improvement in the technical field involving image analysis.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for efficient analysis of image data, the method comprising:
retrieving an image of an area of interest with a first resolution;
performing image analysis on said image with said first resolution to generate an image analysis result and an uncertainty map for said image with said first resolution;
identifying an area in said uncertainty map for said image with said first resolution with an uncertainty beyond a defined uncertainty threshold;
retrieving a segment of said image with a second resolution corresponding to said area in said uncertainty map for said image with said first resolution with said uncertainty beyond said defined uncertainty threshold;
performing image analysis on said segment of said image with said second resolution to generate an image analysis result and an uncertainty map for said image with said second resolution; and
merging said image analysis result of said segment of said image with said second resolution with a corresponding image analysis result of said segment of said image with said first resolution.

2. The method as recited in claim 1, wherein said image with said first resolution corresponds to an image with a first modality, wherein said segment of said image with said second resolution corresponds to an image with said first modality and a second modality.

3. The method as recited in claim 1, wherein said image analysis is performed on said image with said first resolution using a first machine learning model, wherein said image analysis is performed on said segment of said image with said second resolution using a second machine learning model, wherein said second machine learning model is more complex than said first machine learning model by having a greater number of hidden layers of nodes.

4. The method as recited in claim 1, wherein said image analysis performed on said image with said first resolution and said image analysis performed on said segment of said image with said second resolution generate a pixel-wise classification.

5. The method as recited in claim 1 further comprising:
retrieving a segment of said image with a third resolution corresponding to an area in said uncertainty map for said segment of said image with said second resolution with said uncertainty beyond said defined uncertainty threshold, wherein said third resolution has a higher resolution than said second resolution.

6. The method as recited in claim 1 further comprising:
downsampling images of areas of interest with an original resolution with user-defined scaling factors forming images of areas of interest with multiple resolutions; and
storing said images of areas of interest with multiple resolutions, wherein said image of said area of interest with said first resolution is retrieved from said stored images of areas of interest with multiple resolutions.

7. The method as recited in claim 6, wherein said second resolution has a higher resolution than said first resolution

8. A computer program product for efficient analysis of image data, the computer program product comprising one or more computer readable storage mediums having program code embodied therewith, the program code comprising programming instructions for:
retrieving an image of an area of interest with a first resolution;
performing image analysis on said image with said first resolution to generate an image analysis result and an uncertainty map for said image with said first resolution;
identifying an area in said uncertainty map for said image with said first resolution with an uncertainty beyond a defined uncertainty threshold;
retrieving a segment of said image with a second resolution corresponding to said area in said uncertainty map for said image with said first resolution with said uncertainty beyond said defined uncertainty threshold;
performing image analysis on said segment of said image with said second resolution to generate an image analysis result and an uncertainty map for said image with said second resolution; and
merging said image analysis result of said segment of said image with said second resolution with a corresponding image analysis result of said segment of said image with said first resolution.

9. The computer program product as recited in claim 8, wherein said image with said first resolution corresponds to an image with a first modality, wherein said segment of said image with said second resolution corresponds to an image with said first modality and a second modality.

10. The computer program product as recited in claim 8, wherein said image analysis is performed on said image with said first resolution using a first machine learning model, wherein said image analysis is performed on said segment of said image with said second resolution using a second machine learning model, wherein said second machine learning model is more complex than said first machine learning model by having a greater number of hidden layers of nodes.

11. The computer program product as recited in claim 8, wherein said image analysis performed on said image with said first resolution and said image analysis performed on said segment of said image with said second resolution generate a pixel-wise classification.

12. The computer program product as recited in claim 8, wherein the program code further comprises the programming instructions for:
retrieving a segment of said image with a third resolution corresponding to an area in said uncertainty map for said segment of said image with said second resolution with said uncertainty beyond said defined uncertainty threshold, wherein said third resolution has a higher resolution than said second resolution.

13. The computer program product as recited in claim 8, wherein the program code further comprises the programming instructions for:
downsampling images of areas of interest with an original resolution with user-defined scaling factors forming images of areas of interest with multiple resolutions; and
storing said images of areas of interest with multiple resolutions, wherein said image of said area of interest with said first resolution is retrieved from said stored images of areas of interest with multiple resolutions.

14. The computer program product as recited in claim 13, wherein said second resolution has a higher resolution than said first resolution

15. A system, comprising:
a memory for storing a computer program for efficient analysis of image data; and
a processor connected to said memory, wherein said processor is configured to execute program instructions of the computer program comprising:
retrieving an image of an area of interest with a first resolution;
performing image analysis on said image with said first resolution to generate an image analysis result and an uncertainty map for said image with said first resolution;
identifying an area in said uncertainty map for said image with said first resolution with an uncertainty beyond a defined uncertainty threshold;
retrieving a segment of said image with a second resolution corresponding to said area in said uncertainty map for said image with said first resolution with said uncertainty beyond said defined uncertainty threshold;
performing image analysis on said segment of said image with said second resolution to generate an image analysis result and an uncertainty map for said image with said second resolution; and
merging said image analysis result of said segment of said image with said second resolution with a corresponding image analysis result of said segment of said image with said first resolution.

16. The system as recited in claim 15, wherein said image with said first resolution corresponds to an image with a first modality, wherein said segment of said image with said second resolution corresponds to an image with said first modality and a second modality.

17. The system as recited in claim 15, wherein said image analysis is performed on said image with said first resolution using a first machine learning model, wherein said image analysis is performed on said segment of said image with said second resolution using a second machine learning model, wherein said second machine learning model is more complex than said first machine learning model by having a greater number of hidden layers of nodes.

18. The system as recited in claim 15, wherein said image analysis performed on said image with said first resolution and said image analysis performed on said segment of said image with said second resolution generate a pixel-wise classification.

19. The system as recited in claim 15, wherein the program instructions of the computer program further comprise:
retrieving a segment of said image with a third resolution corresponding to an area in said uncertainty map for said segment of said image with said second resolution with said uncertainty beyond said defined uncertainty threshold, wherein said third resolution has a higher resolution than said second resolution.

20. The system as recited in claim 15, wherein the program instructions of the computer program further comprise:
downsampling images of areas of interest with an original resolution with user-defined scaling factors forming images of areas of interest with multiple resolutions; and
storing said images of areas of interest with multiple resolutions, wherein said image of said area of interest with said first resolution is retrieved from said stored images of areas of interest with multiple resolutions.
